(19) United States
(12) Patent Application Publication
(10) Pub. No.: US 2026/0085791 A1
(43) Pub. Date: Mar. 26, 2026

(54) GAS SUPPLY DEVICE AND GAS SUPPLY METHOD

(71) Applicant: MITSUBISHI HEAVY INDUSTRIES, LTD., Tokyo (JP)

(72) Inventor: Koki FUKUDA, Tokyo (JP)

(21) Appl. No.: 19/207,364

(22) Filed: May 14, 2025

(30) Foreign Application Priority Data
Sep. 10, 2024 (JP) 2024-155518

(51) Int. Cl. F17C 7/04

(52) U.S. Cl. CPC F17C 7/04; F17C 2205/0335; F17C 2223/0153

(57) ABSTRACT

A gas supply device of the disclosure includes: a liquefied gas vessel in which liquefied gas is stored; an injector configured to discharge the liquefied gas sucked from the liquefied gas vessel; a first liquefied gas supply path through which the liquefied gas is selectively allowed to flow from the liquefied gas vessel toward the injector; a gas supply path through which gas is selectively supplied to a gas utilization unit, the gas being obtained by vaporizing the liquefied gas flowing in from the injector during flowing through the gas supply path; and a drive fluid supply path through which the gas obtained in the gas supply path is selectively supplied as a drive fluid to the injector.

### CROSS-REFERENCE TO RELATED APPLICATIONS

This application claims the benefit of priority to Japanese Patent Application Number 2024-155518 filed on Sep. 10, 2024. The entire contents of the above-identified application are hereby incorporated by reference.

### TECHNICAL FIELD

The disclosure relates to a gas supply device and a gas supply method.

### RELATED ART

A liquefied hydrogen fuel supply system is known that is configured to feed liquefied hydrogen stored in a liquefied hydrogen tank to a vaporizer by a liquefied hydrogen pump and supply the vaporized hydrogen to a hydrogen engine.

Japanese Unexamined Patent Application Publication No. 2024-76195 discloses a hydrogen engine system including a liquefied hydrogen tank in which liquefied hydrogen is stored at an extremely low temperature, a liquefied hydrogen pump configured to pressurize the liquefied hydrogen stored in the liquefied hydrogen tank and feed the liquefied hydrogen to a vaporizer, the vaporizer configured to vaporize the liquefied hydrogen fed by the liquefied hydrogen pump, and a tank in which high-pressure hydrogen gas is stored. A positive displacement piston-type pump for pressurizing by reciprocating motion of a piston or a turbo-type pump for pressurizing by rotating an impeller is generally used as the liquefied hydrogen pump that pressurizes liquefied hydrogen.

### SUMMARY

The positive displacement piston-type pump that pressurizes extremely low-temperature liquefied hydrogen by the piston has problems with durability, elasticity, or the like under an extremely low-temperature environment to be solved on a piston ring that seals between a cylinder tube and the piston. In addition, the turbo-type pump that rotates the impeller to apply pressure includes a motor and the impeller; therefore, when the pump is mounted in a moving body, the weight of the moving body may increase to cause fuel consumption to be deteriorated.

As described above, an object of the disclosure is to provide a gas supply device that can supply gas obtained by vaporizing liquefied gas to a gas utilization unit without using a pump having the problem with sealing or weight in a movable portion.

A gas supply device according to the disclosure includes:
a liquefied gas vessel in which liquefied gas is stored;
an injector configured to discharge the liquefied gas sucked from the liquefied gas vessel;
a first liquefied gas supply path through which the liquefied gas is selectively allowed to flow from the liquefied gas vessel toward the injector;
a gas supply path through which gas is selectively supplied to a gas utilization unit, the gas being obtained by vaporizing the liquefied gas flowing in from the injector during flowing through the gas supply path; and
a drive fluid supply path through which the gas obtained in the gas supply path is selectively supplied as a drive fluid to the injector.

A gas supply method according to the disclosure includes:
allowing gas obtained by vaporizing liquefied gas to flow as a drive fluid and thereby drawing the liquefied gas from a liquefied gas supply source; and
using the gas obtained by vaporizing the liquefied gas to be drawn as the drive fluid and supplying the gas to a gas utilization unit.

According to the disclosure, the gas supply device that can supply gas obtained by vaporizing liquefied gas to the gas utilization unit without using a pump having the problem with sealing or weight in a movable portion can be provided.

### BRIEF DESCRIPTION OF DRAWINGS

The disclosure will be described with reference to the accompanying drawings, wherein like numbers reference like elements.

FIG. 1 is a diagram illustrating a gas supply device according to a first embodiment of the disclosure.

FIG. 2 is a diagram illustrating a production and supply procedure of gas by the gas supply device according to the first embodiment of the disclosure.

FIG. 3 is a diagram illustrating the production and supply procedure of gas by the gas supply device according to the first embodiment of the disclosure.

FIG. 4 is a diagram illustrating a gas supply device according to a second embodiment of the disclosure.

### DESCRIPTION OF EMBODIMENTS

An embodiment of the disclosure will be described below with reference to the accompanying drawings.

The present embodiment includes at least a first embodiment and a second embodiment.

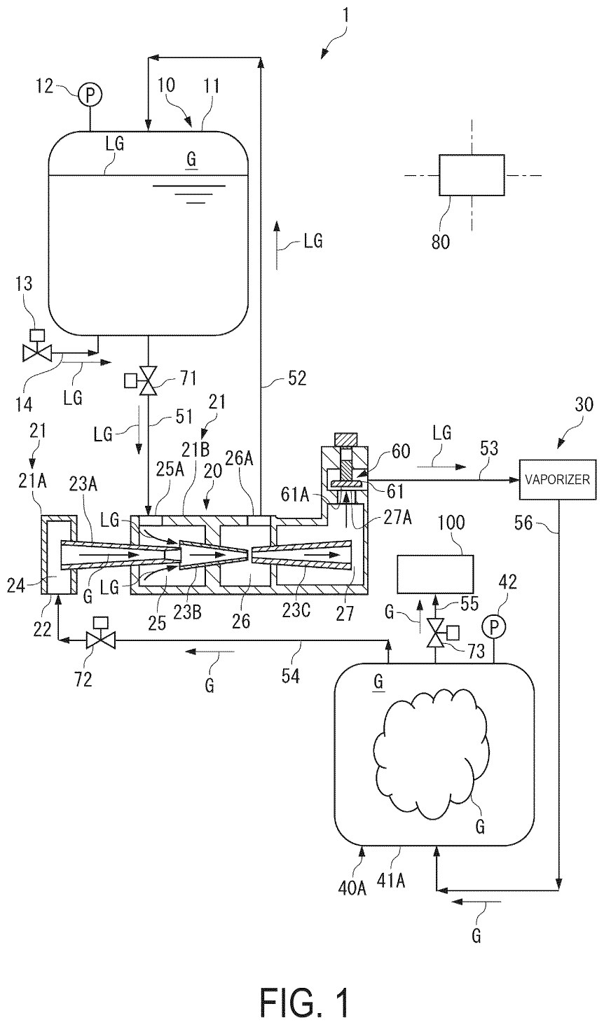

### First Embodiment: See FIGS. 1 to 3

As an example, a gas supply device 1 according to the present embodiment is a gas supply device configured to supply gas obtained by vaporizing liquefied gas to a gas utilization unit. According to the gas supply device 1, the gas obtained by vaporizing the liquefied gas can be used as a drive fluid for sending the liquefied gas and supplied to the gas utilization unit without using a pump having the problem with sealing or weight in a movable portion. Examples of the liquefied gas include liquefied hydrogen, liquefied natural gas (LNG), liquefied ammonia, and the like.

The gas supply device 1 supplies gas obtained by vaporizing liquefied gas to, for example, an engine or a fuel cell of an aircraft, an unmanned aircraft, a drone, or the like.

### Gas Supply Device 1: See FIG. 1

As illustrated in FIG. 1, the gas supply device 1 includes a liquefied gas vessel 10 in which liquefied gas LG is stored, an injector 20 configured to discharge the liquefied gas LG sucked from the liquefied gas vessel 10, a first liquefied gas supply path 51 through which the liquefied gas LG is selectively allowed to flow from the liquefied gas vessel 10 to the injector 20, a gas supply path through which gas G is selectively supplied to a gas utilization unit 100, the gas G being obtained by vaporizing the liquefied gas LG flowing in from the injector 20 during flowing through the gas supply path, a drive fluid supply path 54 through which the gas G obtained in the gas supply path is selectively supplied as a drive fluid to the injector 20, and a control unit 80 configured to control an operation of each device of the gas supply device 1.

Further, the gas supply path includes a gas vessel 40A in which the gas G obtained by vaporizing the liquefied gas LG is stored, and a vaporizing function to vaporize the liquefied gas LG upstream of the gas vessel 40A. The vaporizing function in the present embodiment is a vaporizer 30. The drive fluid supply path 54 is led out from the gas vessel 40A.

Furthermore, the gas supply path includes a second liquefied gas supply path 53 through which the liquefied gas LG is selectively allowed to flow from the injector 20 toward the vaporizer 30, a check valve 60 disposed in the middle of the second liquefied gas supply path 53 to prevent backflow of the liquefied gas LG, a gas flow path 56 through which the gas G flows from the vaporizer 30 toward the gas vessel 40A, and a first gas supply path 55 through which the gas G is selectively allowed to flow from the gas vessel 40A toward the gas utilization unit 100.

“Selectively allowed to flow” means that, for example, fluid may flow or not flow through the flow path in accordance with opening and closing of a valve.

The vaporizing function to vaporize the liquefied gas LG may be achieved, for example, by forming a pipe connecting from the injector 20 to the gas vessel 40A as a double pipe, allowing the liquefied gas LG to flow through an inner pipe, and allowing a high-temperature heat medium to flow between the inner pipe and an outer pipe. The liquefied gas LG is vaporized by heat exchange between the liquefied gas LG and the high-temperature heat medium.

Note that when the pressure and supply amount of the gas G required by the gas utilization unit 100 can be achieved, a double pipe having a vaporizing function may be directly connected from the injector 20 to the gas utilization unit 100 to supply the gas G to the gas utilization unit 100 without providing the gas vessel 40A.

In addition, the gas supply device 1 includes an overflow path 52 through which the liquefied gas LG flows from the injector 20 toward the liquefied gas vessel 10 when the check valve 60 is closed.

In FIG. 1 and the like, the arrows illustrated among the liquefied gas vessel 10, the injector 20, the vaporizer 30, the gas vessel 40A, and the gas utilization unit 100 indicate directions in which the liquefied gas LG or the gas G flows.

### Liquefied Gas Vessel 10: See FIG. 1

The liquefied gas vessel 10 stores the liquefied gas LG therein. In order to maintain the liquefied gas LG in a liquid state, the liquefied gas vessel 10 is subjected to thermal insulation treatment for reducing heat input to the liquefied gas LG from the surroundings of the liquefied gas vessel 10. As an example, the liquefied gas vessel 10 has a double tank structure of an inner tank and an outer tank, a heat insulating material is filled in a space between the inner tank and the outer tank, and the space between the inner tank and the outer tank is evacuated. Thus, thermal insulation treatment is applied. For example, a granular heat insulating material such as pearlite excellent in low-temperature insulation may be used as the heat insulating material.

As illustrated in FIG. 1, the liquefied gas vessel 10 includes a pressure vessel body 11 in which the liquefied gas LG is stored therein, a first pressure detecting unit 12 configured to detect pressure of the gas G inside the pressure vessel body 11, a filling valve 13 configured to switch between start and stop of filling of the liquefied gas LG from a liquefied gas supply source (not illustrated) in order to fill the liquefied gas LG into the pressure vessel body 11 from the outside, and a filling path 14 through which the liquefied gas LG to be filled flows. In addition, the storage amount of the liquefied gas LG in the pressure vessel body 11 is detected by a liquid level detecting unit (not illustrated), and the detection result is acquired by the control unit 80. The control unit 80 that has received the detection result determines whether the upper limit filling amount or the lower limit filling amount of the liquefied gas LG to the liquefied gas vessel 10 has been reached.

The liquefied gas LG is stored on the lower side of the pressure vessel body 11, and the gas G obtained by vaporizing the liquefied gas LG is stored above the liquid level of the liquefied gas LG.

The first liquefied gas supply path 51 and the filling path 14 are connected to a bottom portion of the pressure vessel body 11. The first pressure detecting unit 12 and the overflow path 52 are connected to a top portion of the pressure vessel body 11.

A liquefied gas supply valve 71 is disposed in the middle of the first liquefied gas supply path 51. When the liquefied gas supply valve 71 is opened, the liquefied gas vessel 10 and the injector 20 are brought into a communication state, and the liquefied gas LG can flow to the injector 20. In the present embodiment, the liquefied gas supply valve 71 is a control valve to be controlled by the control unit 80. At the time of starting the flow of the liquefied gas LG from the liquefied gas vessel 10 to the injector 20, the liquefied gas supply valve 71 is opened by the control unit 80. In addition, at the time of stopping the flow of the liquefied gas LG from the liquefied gas vessel 10 to the injector 20, the liquefied gas supply valve 71 is closed by the control unit 80.

The first pressure detecting unit 12 detects the pressure of the gas G inside the pressure vessel body 11. The detection result detected by the first pressure detecting unit 12 is acquired by the control unit 80.

The filling valve 13 is closed except when it comes to filling the liquefied gas vessel 10 with the liquefied gas LG. The filling valve 13 is a manual valve in the present embodiment, but may be a control valve to be controlled by the control unit 80. The liquefied gas LG is filled through the filling path 14 into the liquefied gas vessel 10 from the liquefied gas supply source connected to the filling valve 13.

In the present embodiment, in order to supply the gas G to the gas utilization unit 100 over a long period of time, it is desirable that a large amount of the liquefied gas LG can be stored in the liquefied gas vessel 10. In addition, the liquefied gas vessel 10 is kept at low pressure. Here, the low pressure is, for example, about 1 to 2 atmospheres in gauge pressure.

The gas vessel 40A stores the gas G obtained by vaporizing the liquefied gas LG in which the gas G has reached high pressure. Here, the high pressure is, for example, about 10 atmospheres in gauge pressure.

### Injector 20: See FIG. 1

The injector 20 discharges the liquefied gas LG supplied from the liquefied gas vessel 10 toward the vaporizer 30. Note that the injector 20 produces a predetermined low-pressure state therein and thus sucks the liquefied gas LG in to be stored in the liquefied gas vessel 10.

As illustrated in FIG. 1, the injector 20 includes a plurality of nozzles 23A, 23B, 23C coaxially arranged and an injector body 21 in which the plurality of nozzles are disposed therein.

The plurality of nozzles 23A, 23B, 23C are arranged in the order of a gas nozzle 23A, a mixing nozzle 23B, and a conveyance nozzle 23C from the upstream to the downstream of the flow of the liquefied gas LG and the gas G flowing through the injector 20. In other words, the inlet side of each of the gas nozzle 23A, the mixing nozzle 23B, and the conveyance nozzle 23C is the left side on the paper of FIG. 1, and the discharge port side thereof is the right side on the paper of FIG. 1.

The plurality of nozzles 23A, 23B, 23C include the gas nozzle 23A configured to increase the flow velocity of the gas G as the drive fluid supplied from the gas vessel 40A, the mixing nozzle 23B configured to mix the liquefied gas LG sucked from the liquefied gas vessel 10 and the gas G having passed through the gas nozzle 23A, and the conveyance nozzle 23C configured to convey a mixture of the gas G and the liquefied gas LG both having passed through the mixing nozzle 23B. The mixture of the gas G and the liquefied gas LG is, for example, a state of a simple substance of the liquefied gas LG in which the liquefied gas LG obtained by cooling the gas G by the liquefied gas LG and then liquefying the gas G again and the liquefied gas LG sucked from the liquefied gas vessel 10 are mixed. In addition, for example, the mixture of the gas G and the liquefied gas LG is in a gas-liquid mixed state in which the gas G in a gaseous state is mixed with the liquefied gas LG. In the present embodiment, a mode will be described in which the mixture of the gas G and the liquefied gas LG flows in a state of a simple substance of the liquefied gas LG.

The injector body 21 includes a first body 21A on the upstream side into which the gas G is introduced and a second body 21B on the downstream side from which the introduced gas G and the liquefied gas LG are mixed to be discharged.

The first body 21A is provided with an introduction region 24 from which the gas G is introduced into the gas nozzle 23A.

The second body 21B is provided with a mixing region 25 in which the liquefied gas LG is introduced into the mixing nozzle 23B, an overflow region 26 in which the liquefied gas LG discharged from the mixing nozzle 23B flows when the check valve 60 is closed, and a conveyance region 27 in which the liquefied gas LG discharged from the conveyance nozzle 23C is conveyed toward an outlet of the injector 20.

The introduction region 24 is provided with a receiving port 22 by which the gas G as the drive fluid supplied from the gas vessel 40A is received.

The mixing region 25 is provided with a suction port 25A by which the liquefied gas LG sucked from the liquefied gas vessel 10 is received.

The overflow region 26 is provided with an overflow outlet 26A from which the liquefied gas LG as a mixture discharged from the mixing nozzle 23B flows out toward the liquefied gas vessel 10 when the check valve 60 is closed.

The conveyance region 27 is provided with a discharge port 27A from which the mixture discharged from the conveyance nozzle 23C is discharged.

The gas G supplied from the receiving port 22 is introduced into the gas nozzle 23A through the introduction region 24.

The cross-sectional area of the gas nozzle 23A is decreased from the inlet side toward the discharge port side. The gas G supplied as the drive fluid from the gas vessel 40A enters from the inlet of the gas nozzle 23A and passes through the flow path of the gas nozzle 23A whose cross-sectional area is decreased. Thus, the flow velocity of the gas G is increased. By increasing the flow velocity of the gas G and discharging the gas G, whose pressure has been decreased by a Venturi effect, into the mixing region 25, a predetermined low pressure state is generated in the mixing region 25. The liquefied gas LG stored in the liquefied gas vessel 10 is sucked into the mixing region 25 by the predetermined low-pressure state generated in the mixing region 25. The gas G discharged from the discharge port of the gas nozzle 23A is supplied to the mixing nozzle 23B.

The liquefied gas LG sucked from the liquefied gas vessel 10 into the mixing region 25 and the gas G having passed through the gas nozzle 23A are introduced into the mixing nozzle 23B.

The cross-sectional area of the mixing nozzle 23B is decreased from the inlet side to the discharge port side. From the inlet of the mixing nozzle 23B, the gas G having passed through the gas nozzle 23 A and the liquefied gas LG sucked from the liquefied gas vessel 10 are introduced. The gas G and the liquefied gas LG are allowed to pass through the flow path of the mixing nozzle 23B, the cross-sectional area is gradually decreased, while being mixed. Thus, the flow velocity of the mixture of the gas G and the liquefied gas LG is increased. The flow velocity of the liquefied gas LG as the mixture is increased, and the liquefied gas LG whose pressure has been decreased by the Venturi effect, is discharged toward the conveyance nozzle 23C. The low-pressure liquefied gas LG is supplied to the conveyance nozzle 23C.

Note that when the internal pressure of the mixing region 25 reaches a predetermined low-pressure state, the momentum of the mixture of the gas G and the liquefied gas LG, passing through the mixing nozzle 23B is maximized.

The conveyance nozzle 23C increases the pressure of the mixture discharged from the mixing nozzle 23B and discharges the liquefied gas LG to the conveyance region 27.

The cross-sectional area of the conveyance nozzle 23C is increased from the inlet side toward the discharge port side. The mixture having passed through the mixing nozzle 23B is introduced from the inlet of the conveyance nozzle 23C, and the liquefied gas LG is allowed to pass through the flow path of the conveyance nozzle 23C whose cross-sectional area is gradually increased. Thus, the flow velocity of the liquefied gas LG is decreased. The flow velocity of the liquefied gas LG is decreased, and the liquefied gas LG, whose pressure has been increased by the Venturi effect, is discharged to the conveyance region 27.

The liquefied gas LG discharged from the conveyance nozzle 23C flows through the conveyance region 27 and is discharged from the discharge port 27A. When the pressure of the liquefied gas LG discharged from the discharge port 27A is higher than the pressure on the downstream side of the check valve 60, the check valve 60 opens, and the liquefied gas LG flows through the second liquefied gas supply path 53 and is supplied to the vaporizer 30.

When the pressure of the liquefied gas LG in the conveyance region 27 is lower than the pressure on the downstream side of the check valve 60, the check valve 60 does not open and the liquefied gas LG is not supplied to the vaporizer 30. Note that the check valve 60 does not open and thus the fluid does not flow backward from the vaporizer 30 toward the injector 20.

When the check valve 60 does not open and the liquefied gas LG is not discharged from the conveyance region 27, the liquefied gas LG is discharged from the overflow outlet 26A of the overflow region 26 on the upstream side of the conveyance region 27 and flows through the overflow path 52 to be sent to the liquefied gas vessel 10.

### Check Valve 60: See FIG. 1

The check valve 60 prevents the fluid from flowing backward from the gas vessel 40A toward the injector 20.

The check valve 60 is disposed in the middle of the second liquefied gas supply path 53. In the present embodiment, the check valve 60 is disposed most upstream of the second liquefied gas supply path 53. The check valve 60 includes a valve body 61 movable in the up-down direction on the paper of the drawing, and the valve body 61 is provided with a closing surface 61A configured to come into contact with an outer peripheral edge of the discharge port 27A and close the discharge port 27A. When the primary-side pressure upstream of the check valve 60 exceeds the secondary-side pressure at the downstream side of the check valve 60, the check valve 60 is opened. When the check valve 60 is opened, the liquefied gas LG is sent from the injector 20 through the second liquefied gas supply path 53 toward the vaporizer 30.

The pressure of the gas G stored in the gas vessel 40A is, for example, about 10 atmospheres in gauge pressure. Since the vaporizer 30 is disposed between the check valve 60 and the gas vessel 40A, the pressure of the gas G in the gas vessel 40A reaches the check valve 60 via the vaporizer 30. In other words, in order to open the check valve 60, the pressure of the liquefied gas LG in the conveyance region 27 needs to exceed the pressure of the gas G in the gas vessel 40A.

When the internal pressure of the mixing region 25 of the injector 20 reaches a predetermined low-pressure state, the liquefied gas LG having the maximized momentum is supplied to the conveyance region 27, and the pressure of the liquefied gas LG in the conveyance region 27 exceeds the pressure of the gas G in the gas vessel 40A. Therefore, the check valve 60 opens.

### Vaporizer 30: See FIG. 1

The vaporizer 30 has a vaporizing function and vaporizes the supplied liquefied gas LG to produce the gas G. The produced gas G is supplied through the gas flow path 56 to the gas vessel 40A.

The vaporizer 30 is disposed at the upstream of the gas vessel 40A and is supplied with the liquefied gas LG discharged from the injector 20. The vaporizer 30 vaporizes the supplied liquefied gas LG to obtain the gas G. The vaporizer 30 is a heat exchanger configured to vaporize the liquefied gas LG flowing inside by heat exchange with a heat medium. The heat medium to be heat-exchanged with the liquefied gas LG may be, for example, a liquid such as water or a gas such as carbon dioxide.

### Gas Vessel 40A: See FIG. 1

The gas vessel 40A stores the gas G supplied from the vaporizer 30 and selectively supplies the stored gas G to the gas utilization unit 100.

The gas vessel 40A includes a vessel body 41A in which the gas G is stored and a second pressure detecting unit 42 configured to detect the pressure of the gas G stored in the vessel body 41A.

The gas flow path 56 is connected to a bottom portion of the vessel body 41A. In addition, the drive fluid supply path 54, the first gas supply path 55, and the second pressure detecting unit 42 are connected to a top portion of the vessel body 41A.

A drive fluid supply valve 72 is disposed in the middle of the drive fluid supply path 54. When the drive fluid supply valve 72 is opened, the gas vessel 40A and the injector 20 are brought into communication with each other, and the gas G as the drive fluid can be supplied to the injector 20. In the present embodiment, the drive fluid supply valve 72 is a control valve to be controlled by the control unit 80. At the time of starting the supply of the gas G from the gas vessel 40A to the injector 20, the drive fluid supply valve 72 is opened by the control unit 80. Also, at the time of stopping the supply of the gas G from the gas vessel 40A to the injector 20, the drive fluid supply valve 72 is closed by the control unit 80.

A gas supply valve 73 is disposed in the middle of the first gas supply path 55. When the gas supply valve 73 is opened, the gas vessel 40A and the gas utilization unit 100 are brought into communication with each other, and the gas G can be supplied to the gas utilization unit 100. In the present embodiment, the gas supply valve 73 is a control valve to be controlled by the control unit 80. At the time of starting the supply of the gas G from the gas vessel 40A to the gas utilization unit 100, the gas supply valve 73 is opened by the control unit 80. Also, at the time of stopping the supply of the gas G from the gas vessel 40A to the gas utilization unit 100, the gas supply valve 73 is closed by the control unit 80.

The second pressure detecting unit 42 is configured to detect internal pressure of the vessel body 41A. Specifically, the pressure of the gas G obtained by vaporizing the liquefied gas LG and stored in the vessel body 41A is detected. The detection result detected by the second pressure detecting unit 42 is acquired by the control unit 80.

### Control Unit 80: See FIG. 1

The control unit 80 controls the operation of each device of the gas supply device 1.

The control unit 80 controls switching between opening and closing of each of the liquefied gas supply valve 71, the drive fluid supply valve 72, and the gas supply valve 73. In addition, the control unit 80 receives the detection results of the first pressure detecting unit 12 and the second pressure detecting unit 42. The control unit 80 may control switching between opening and closing of each valve based on the detection results of the first pressure detecting unit 12 and the second pressure detecting unit 42.

The control unit 80 includes an output unit (not illustrated) configured to notify an operator of a state of the gas supply device 1. For example, the output unit notifies an operator that the upper limit filling amount of the liquefied gas LG in the liquefied gas vessel 10 has been reached.

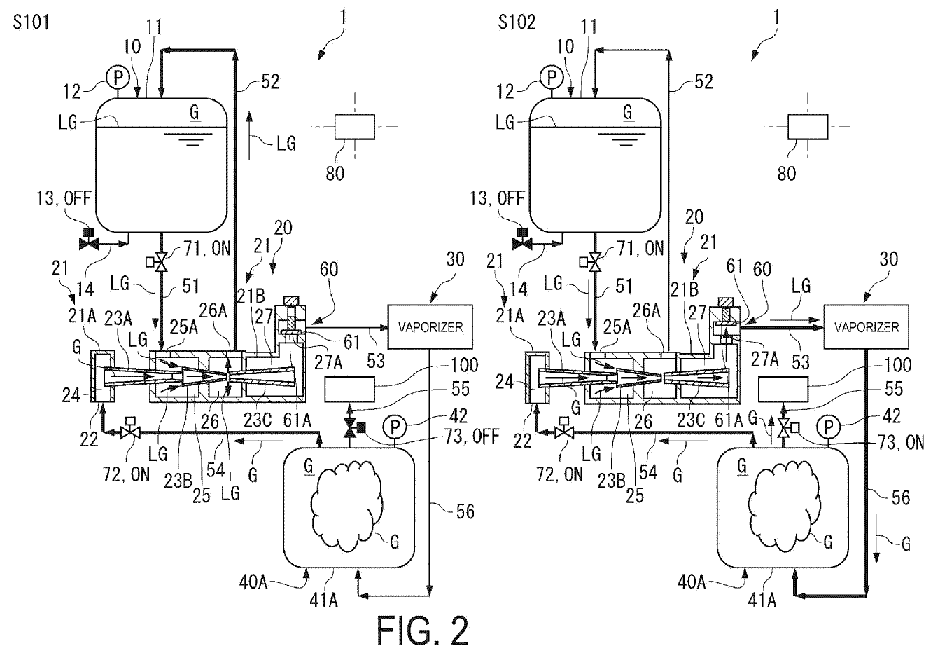

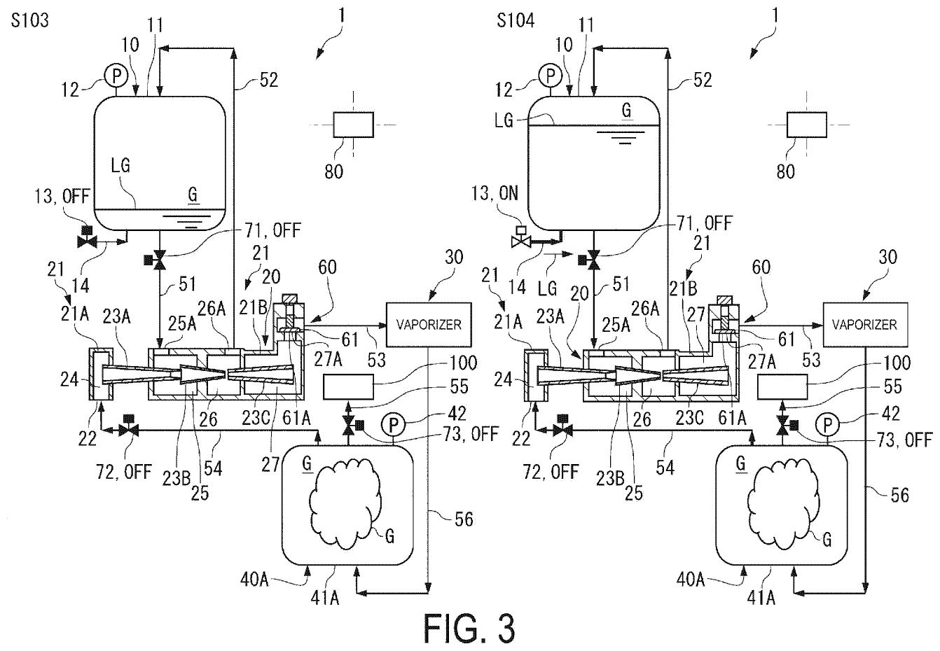

### Gas Production and Supply Procedure: See FIGS. 2 and 3

Hereinafter, the generation and supply procedure (a gas supply method) of the gas G in the gas supply device 1 will be described with reference to FIGS. 2 and 3.

Note that the generation and supply procedure of the gas G described below is performed in accordance with instructions from the control unit 80. Further, before starting this procedure, the inside of the liquefied gas vessel 10 and the injector 20 is replaced with, for example, the gas G obtained by vaporizing the liquefied gas LG. Furthermore, the inside of the liquefied gas vessel 10 and the injector 20 may be in a state of medium vacuum (JIS Z 8126-1) of less than 100 Pa and 0.1 Pa or more. In addition, the liquefied gas LG is filled into the liquefied gas vessel 10 in a state of being replaced with the gas G or in a state of medium vacuum, the high-pressure gas G obtained by vaporizing the liquefied gas LG is filled into the vaporizer 30, the gas flow path 56, and the gas vessel 40A, and all of the valves are closed.

In the drawing, a state where the valve is opened is indicated by white, and a state where the valve is closed is indicated by black. Moreover, the closing surface 61A of the valve body 61 is separated from the discharge port 27A, the check valve 60 is open, and when the closing surface 61A is in contact with the outer peripheral edge of the discharge port 27A, the check valve 60 is closed.

### First Step S101: See S101 of FIG. 2

In a first step S101, the liquefied gas supply valve 71 and the drive fluid supply valve 72 are opened. Thus, the gas G as the drive fluid is supplied from the gas vessel 40A through the drive fluid supply path 54 to the injector 20 and flows through the inside of the injector 20. In addition, the liquefied gas LG stored in the liquefied gas vessel 10 serving as the liquefied gas supply source is drawn out by the injector 20 and supplied through the first liquefied gas supply path 51 to the injector 20.

In the first step S101, the liquefied gas LG reaches the conveyance region 27. However, when the pressure of the liquefied gas LG in the conveyance region 27 is lower than the internal pressure of the gas vessel 40A, the check valve 60 does not open, and the liquefied gas LG discharged from the mixing nozzle 23B is returned through the overflow path 52 to the liquefied gas vessel 10.

In addition, the opening and closing states of the valves are summarized below.
Open (ON): liquefied gas supply valve 71, drive fluid supply valve 72
Closed (OFF): gas supply valve 73, filling valve 13

### Second Step S102: See S102 of FIG. 2

Following the first step S101, a second step S102 is executed. In the first step S101, the internal pressure of the mixing region 25 is decreased while allowing the liquefied gas LG to circulate between the liquefied gas vessel 10 and the injector 20, and thus the pressure of the liquefied gas LG in the conveyance region 27 gradually increases. When the internal pressure of the mixing region 25 reaches a predetermined low-pressure state, the momentum of the liquefied gas LG passing through the mixing nozzle 23B is maximized, and the pressure of the liquefied gas LG in the conveyance region 27 of the injector 20 exceeds the internal pressure of the gas vessel 40A. Thus, the check valve 60 is opened. When the check valve 60 is opened, the liquefied gas LG is sent from the injector 20 toward the vaporizer 30. The liquefied gas LG sent from the injector 20 enters the vaporizer 30, and the vaporizer 30 vaporizes the liquefied gas LG.

In the second step S102, the gas supply valve 73 may be opened based on the detection result of the second pressure detecting unit 42. For example, when the pressure of the gas G detected by the second pressure detecting unit 42 starts increasing, it is determined that the check valve 60 is opened, the liquefied gas LG is supplied to the vaporizer 30 and the production of the gas G by the vaporizer 30 is started; therefore, the gas supply valve 73 is opened. In addition, for example, the pressure of the gas G detected by the second pressure detecting unit 42 reaches the pressure required by the gas utilization unit 100; thereafter, the gas supply valve 73 may be opened. As a result, the gas G is supplied from the gas vessel 40A to the gas utilization unit 100.

In the second step S102, when the check valve 60 is opened and the supply of the liquefied gas LG to the vaporizer 30 is started, the liquefied gas LG does not return through the overflow path 52 to the liquefied gas vessel 10.

Likewise, in the second step S102, the supply of the gas G as the drive fluid from the gas vessel 40A to the injector 20 is continued, and the supply of the liquefied gas LG from the liquefied gas vessel 10 to the injector 20 is also continued.

Note that when the inside of the injector 20 is in a state of medium vacuum before starting the procedure, the inside of the mixing region 25 is also in a state of medium vacuum. In other words, the momentum of the liquefied gas LG passing through the mixing nozzle 23B is maximized along with the start of sucking of the liquefied gas LG from the liquefied gas vessel 10 by the injector 20. Accordingly, along with the start of sucking of the liquefied gas LG from the liquefied gas vessel 10 by the injector 20, the pressure of the liquefied gas LG in the conveyance region 27 exceeds the internal pressure of the gas vessel 40A to open the check valve 60, and thus the supply of the liquefied gas LG from the injector 20 to the vaporizer 30 is started.

As a result, in a case where the procedure is started from when the interior of the injector 20 is in a state of medium vacuum, in the first step S101, the liquefied gas supply valve 71 and the drive fluid supply valve 72 are opened and the supply of the liquefied gas LG from the injector 20 to the vaporizer 30 is started. Next, the production of the gas G is started by the vaporizer 30, and thus the second step S102 is executed immediately after the first step S101.

In addition, the opening and closing states of the valves in the second step S102 are summarized below.
Open (ON): liquefied gas supply valve 71, drive fluid supply valve 72, gas supply valve 73
Closed (OFF): filling valve 13

### Third Step S103: See S103 of FIG. 3

When the filling amount of the liquefied gas LG stored in the liquefied gas vessel 10 becomes equal to or less than the lower limit filling amount, a third step S103 is executed following the second step S102.

In the third step S103, when the control unit 80 that has received the detection result detected by a liquid level detecting unit (not illustrated) determines that the filling amount of the liquefied gas LG stored in the liquefied gas vessel 10 is equal to or less than the lower limit filling amount, the liquefied gas supply valve 71, the drive fluid supply valve 72, and the gas supply valve 73 are closed. Thus, the supply of the gas G from the gas vessel 40A to the gas utilization unit 100 is stopped, and the supply of the liquefied gas LG from the injector 20 to the vaporizer 30 is stopped.

In addition, the opening and closing states of the valves in the third step S103 are summarized below.
Open (ON): none
Closed (OFF): liquefied gas supply valve 71, drive fluid supply valve 72, gas supply valve 73, filling valve 13

### Fourth Step S104: See S104 of FIG. 3

Following the third step S103, a fourth step S104 is executed.

In the fourth step S104, the filling valve 13 connected to the supply source of the liquefied gas LG (not illustrated) is opened by an operator, and thus filling of the liquefied gas LG into the liquefied gas vessel 10 is started. When the liquefied gas LG in the liquefied gas vessel 10 reaches the upper limit filling amount, the operator closes the filling valve 13 to stop filling of the liquefied gas LG into the liquefied gas vessel 10. Whether the upper limit filling amount has been reached is determined by the control unit 80 that has received the detection result detected by the liquid level detecting unit (not illustrated), and when the filling amount of the liquefied gas LG reaches the upper limit filling amount, an alarm is issued from the output unit included in the control unit 80.

After filling of the liquefied gas LG into the liquefied gas vessel 10 is completed, the supply of the gas G as the drive fluid from the gas vessel 40A to the injector 20 is resumed, and the supply of the liquefied gas LG from the liquefied gas vessel 10 to the injector 20 is resumed. When the pressure of the liquefied gas LG in the conveyance region 27 exceeds the internal pressure of the gas vessel 40A, the liquefied gas LG is supplied to the vaporizer 30, and thus the production of the gas G is resumed. When the supply of the gas G to the gas vessel 40A is resumed, the supply of the gas G to the gas utilization unit 100 is resumed.

### Effects

The gas supply device 1 according to the present embodiment described above achieves the following effects.

### First Effect

The gas supply device 1 includes the injector 20 configured to discharge the liquefied gas LG sucked from the liquefied gas vessel 10, and the gas supply path through which the gas G obtained by vaporizing, in the vaporizer 30, the liquefied gas LG flowing thereinto from the injector 20 is selectively supplied to the gas utilization unit 100.

The gas supply device 1 supplies the gas G obtained by vaporizing, in the vaporizer 30, the liquefied gas LG supplied from the injector 20, to the gas utilization unit 100 and thus can supply the gas obtained by vaporizing the liquefied gas to the gas utilization unit without using a pump having the problem with sealing or weight in a movable portion.

### Second Effect

The gas supply device 1 includes the check valve 60 configured to prevent backflow of the fluid to the injector 20. By providing the check valve 60 between the injector 20 and the gas vessel 40A, the pressure of the liquefied gas LG sent from the injector 20 can be increased above the pressure of the gas G in the gas vessel 40A while preventing the function of the injector 20 from being disabled due to the backflow of the gas G in the gas vessel 40A.

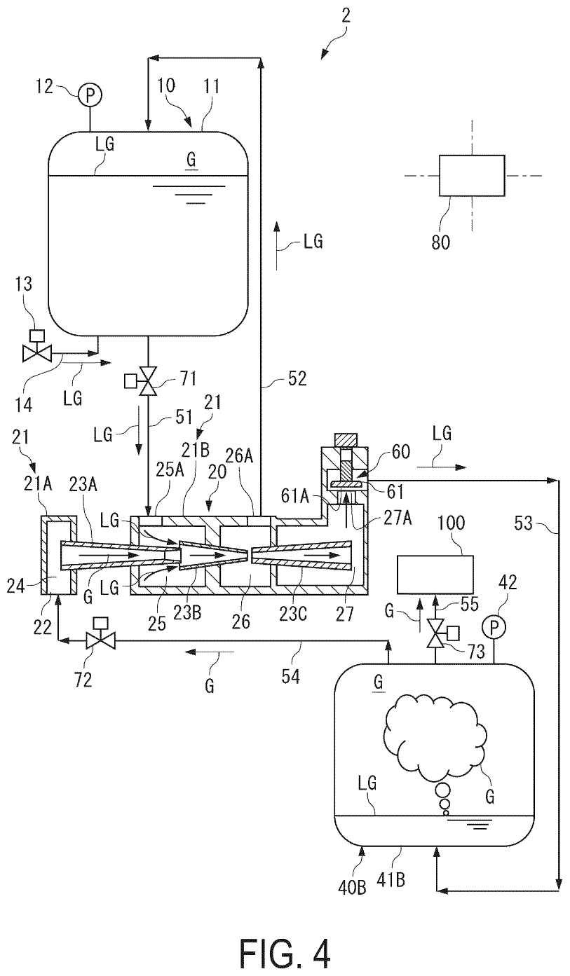

### Second Embodiment: See FIG. 4

A gas supply device 2 according to a second embodiment of the disclosure is different from the gas supply device 1 according to the first embodiment in that the vaporizer 30 is not provided. In the gas supply device 1 of the first embodiment, since the gas G is obtained by vaporizing the liquefied gas LG with the vaporizer 30, the functions are divided between the vaporizer 30 configured to produce the gas G and the gas vessel 40A in which the gas G is stored. However, in the gas supply device 2 of the second embodiment, since the vaporizer 30 is not provided, a gas vessel 40B bears the function to vaporize the liquefied gas LG. In FIG. 4, the same components as those in the first embodiment are denoted by the same reference signs as those in FIG. 1, and detailed description thereof will be omitted.

Likewise, in the gas supply device 2 according to the present embodiment, the gas obtained by vaporizing the liquefied gas can be supplied to the gas utilization unit without using a pump having the problem with sealing or weight in a movable portion.

### Gas Vessel 40B: See FIG. 4

The gas vessel 40B stores the liquefied gas LG supplied from the injector 20 and selectively supplies the gas G produced by vaporizing the stored liquefied gas LG to the gas utilization unit 100.

The gas vessel 40B includes a vessel body 41B in which the liquefied gas LG and the gas G are stored, and the second pressure detecting unit 42 configured to detect the pressure of the gas G stored in the vessel body 41B.

The gas vessel 40B is provided with a heat input unit (not illustrated) capable of selectively exchanging heat with the liquefied gas LG stored in the gas vessel 40B. In addition, in order to produce the gas G in accordance with only the amount of heat input from the heat input unit, the gas vessel 40B is subjected to thermal insulation treatment for reducing heat input from the surroundings of the gas vessel 40B. As an example, the gas vessel 40B has a double tank structure of an inner tank and an outer tank, a heat insulating material is filled in a space between the inner tank and the outer tank, and the space between the inner tank and the outer tank is evacuated. Thus, thermal insulation treatment is applied. For example, a granular heat insulating material such as pearlite excellent in low-temperature insulation may be used as the heat insulating material. The gas vessel 40B can optionally adjust the production amount of the gas G by reducing the influence of heat input from the surroundings with the heat insulation treatment and then inputting heat with the heat input unit. By optionally adjusting the production amount of the gas G, the internal pressure of the gas vessel 40B can be optionally adjusted.

The heat input unit is a metallic body made of copper or aluminum and is configured to be in contact with and separate from the gas vessel 40B by a drive source (not illustrated). The reason why copper or aluminum is adopted to the metallic body is that metal having high thermal conductivity is required to increase the amount of heat input from the heat input unit to the gas vessel 40B. Heat input is started when the metallic body constituting the heat input unit is brought into contact with the gas vessel 40B, and heat input is stopped when the metallic body constituting the heat input unit is separated from the gas vessel 40B.

In addition, the gas vessel 40B may have a double tank structure of an inner tank and an outer tank with a space therebetween in a vacuum state. In this case, the gas vessel 40B may allow carbon dioxide in a gaseous state to selectively flow between the inner tank and the outer tank to input heat to the gas vessel 40B. A space between the inner tank and the outer tank through which carbon dioxide in a gaseous state flows is referred to as a carbon dioxide flow path. When heat input by the heat input unit is started, the flow of carbon dioxide to the carbon dioxide flow path is started. When heat input by the heat input unit is stopped, the flow of carbon dioxide to the carbon dioxide flow path is stopped. When heat input by the heat input unit is stopped, the carbon dioxide in a gaseous state remaining in the middle of the carbon dioxide flow path is cooled and solidified by the liquefied gas LG supplied to the gas vessel 40B. Since the carbon dioxide in a gaseous state remaining in the middle of the carbon dioxide flow path is solidified and the volume is reduced, vacuum insulating is restored. When heat input from the heat input unit is stopped, the space between the inner tank and the outer tank of the gas vessel 40B is brought into a vacuum state, and thus the vacuum insulating effect can be maintained.

The gas vessel 40B allows the heat input unit to selectively input heat and thus produces the gas G by vaporizing the liquefied gas LG supplied to the gas vessel 40B. The liquefied gas LG supplied to the gas vessel 40B is introduced into the gas vessel 40B and vaporized therein, or is stored at a bottom portion of the gas vessel 40B and thereafter is vaporized into the gas G. The vaporized gas G is supplied to the gas utilization unit 100 and the injector 20.

### Effects

The gas supply device 2 according to the present embodiment described above achieves the first effect and the second effect even when the vaporizer 30 is not provided and the gas vessel 40B bears the functions of storing the liquefied gas LG and supplying the gas G produced by vaporizing the liquefied gas LG to the gas utilization unit 100.

### Third Effect

The gas supply device 2 is not provided with the vaporizer 30, and thus the space occupied by the gas supply device 2 can be reduced compared to the gas supply device 1.

### SUPPLEMENTARY NOTES

The gas supply device according to the disclosure can be understood as follows.

### Supplementary Note 1

A gas supply device (1, 2) according to the disclosure includes:
a liquefied gas vessel (10) in which liquefied gas (LG) is stored;
an injector (20) configured to discharge the liquefied gas (LG) sucked from the liquefied gas vessel (10);
a first liquefied gas supply path (51) through which the liquefied gas (LG) is selectively allowed to flow from the liquefied gas vessel (10) toward the injector (20);
a gas supply path (40A, 40B, 53, 55, 56) through which gas (G) is selectively supplied to a gas utilization unit (100), the gas (G) being obtained by vaporizing the liquefied gas (LG) flowing in from the injector (20) during flowing through the gas supply path; and
a drive fluid supply path (54) through which the gas (G) obtained in the gas supply path (40A, 40B, 53, 55, 56) is selectively supplied as a drive fluid to the injector (20).

### Supplementary Note 2

In Supplementary Note 1, the gas supply path (53, 55) preferably includes a gas vessel (40A, 40B) in which the gas (G) obtained by vaporizing the liquefied gas (LG) is stored, and the gas (G) stored in the gas vessel (40A, 40B) is preferably supplied to the gas utilization unit (100).

### Supplementary Note 3

In Supplementary Note 2, the gas supply path (53, 55) preferably includes, upstream of the gas vessel (40A), a vaporizing function (30) to vaporize the liquefied gas (LG), and
in the gas vessel (40A), preferably the gas (G) vaporized by the vaporizing function (30) is stored.

### Supplementary Note 4

In Supplementary Note 3, the vaporizing function (30) is preferably a vaporizer (30) disposed upstream of the gas vessel (40A).

### Supplementary Note 5

In Supplementary Note 2, the gas supply path (53, 55) preferably includes, in the gas vessel (40B), a vaporizing function (30) to vaporize the liquefied gas (LG).

### Supplementary Note 6

In any one of Supplementary Notes 1 to 5, the gas supply path (40A, 40B, 53, 55, 56) preferably includes a check valve (60) configured to prevent backflow of a fluid to the injector (20).

### Supplementary Note 7

In Supplementary Note 6, the gas supply device preferably includes an overflow path (52) through which the liquefied gas (LG) flows from the injector (20) toward the liquefied gas vessel (10) when the check valve (60) is closed.

### Supplementary Note 8

In any one of Supplementary Notes 1 to 7, the injector (20) preferably includes a plurality of nozzles coaxially arranged, and
the plurality of nozzles preferably include:
a gas nozzle (23A) into which the gas (G) as the drive fluid is introduced;
a mixing nozzle (23B) into which the liquefied gas (LG) sucked from the liquefied gas vessel (10) and the gas (G) having passed through the gas nozzle (23A) are introduced; and
a conveyance nozzle (23C) into which a mixture of the liquefied gas (LG) and the gas (G) both having passed through the mixing nozzle (23B) is introduced.

### Supplementary Note 9

In any one of Supplementary Notes 2 to 8, the drive fluid supply path (54) is preferably led out from the gas vessel (40A, 40B).

### Supplementary Note 10

A gas supply method according to the disclosure includes:
allowing gas (G) obtained by vaporizing liquefied gas (LG) to flow as a drive fluid and thereby drawing the liquefied gas (LG) from a liquefied gas supply source (10); and
using the gas (G) obtained by vaporizing the liquefied gas (LG) to be drawn as the drive fluid and supplying the gas (G) to a gas utilization unit (100).

Besides the above-described embodiments, configurations described in the above-described embodiments can be selected or omitted as desired or can be changed to other configurations as necessary.

While preferred embodiments of the disclosure have been described as above, it is to be understood that variations and modifications will be apparent to those skilled in the art without departing from the scope and spirit of the disclosure. The scope of the disclosure, therefore, is to be determined solely by the following claims.

1. A gas supply device comprising:
a liquefied gas vessel in which liquefied gas is stored;
an injector configured to discharge the liquefied gas sucked from the liquefied gas vessel;
a first liquefied gas supply path through which the liquefied gas is selectively allowed to flow from the liquefied gas vessel toward the injector;
a gas supply path through which gas is selectively supplied to a gas utilization unit, the gas being obtained by vaporizing the liquefied gas flowing in from the injector during flowing through the gas supply path; and
a drive fluid supply path through which the gas obtained in the gas supply path is selectively supplied as a drive fluid to the injector.

2. The gas supply device according to claim 1, wherein
the gas supply path includes a gas vessel in which the gas obtained by vaporizing the liquefied gas is stored, and
the gas stored in the gas vessel is supplied to the gas utilization unit.

3. The gas supply device according to claim 2, wherein
the gas supply path includes, upstream of the gas vessel, a vaporizing function to vaporize the liquefied gas, and in the gas vessel, the gas vaporized by the vaporizing function is stored.

4. The gas supply device according to claim 3, wherein the vaporizing function is a vaporizer disposed upstream of the gas vessel.

5. The gas supply device according to claim 2, wherein the gas supply path includes, in the gas vessel, a vaporizing function to vaporize the liquefied gas.

6. The gas supply device according to claim 1, wherein the gas supply path includes a check valve configured to prevent backflow of a fluid to the injector.

7. The gas supply device according to claim 6, comprising an overflow path through which the liquefied gas flows from the injector toward the liquefied gas vessel when the check valve is closed.

8. The gas supply device according to claim 1, wherein
the injector includes a plurality of nozzles coaxially arranged, and
the plurality of nozzles include:
a gas nozzle into which the gas as the drive fluid is introduced;
a mixing nozzle into which the liquefied gas sucked from the liquefied gas vessel and the gas having passed through the gas nozzle are introduced; and
a conveyance nozzle into which a mixture of the liquefied gas and the gas both having passed through the mixing nozzle is introduced.

9. The gas supply device according to claim 3, wherein the drive fluid supply path is led out from the gas vessel.

10. A gas supply method comprising:
allowing gas obtained by vaporizing liquefied gas to flow as a drive fluid and thereby drawing the liquefied gas from a liquefied gas supply source; and
using the gas obtained by vaporizing the liquefied gas to be drawn as the drive fluid and supplying the gas to a gas utilization unit.

11. The gas supply device according to claim 2, wherein the gas supply path includes a check valve configured to prevent backflow of a fluid to the injector.

12. The gas supply device according to claim 3, wherein the gas supply path includes a check valve configured to prevent backflow of a fluid to the injector.

13. The gas supply device according to claim 4, wherein the gas supply path includes a check valve configured to prevent backflow of a fluid to the injector.

14. The gas supply device according to claim 5, wherein the gas supply path includes a check valve configured to prevent backflow of a fluid to the injector.

15. The gas supply device according to claim 2, wherein
the injector includes a plurality of nozzles coaxially arranged, and
the plurality of nozzles include:
a gas nozzle into which the gas as the drive fluid is introduced;
a mixing nozzle into which the liquefied gas sucked from the liquefied gas vessel and the gas having passed through the gas nozzle are introduced; and
a conveyance nozzle into which a mixture of the liquefied gas and the gas both having passed through the mixing nozzle is introduced.

16. The gas supply device according to claim 3, wherein
the injector includes a plurality of nozzles coaxially arranged, and
the plurality of nozzles include:
a gas nozzle into which the gas as the drive fluid is introduced;
a mixing nozzle into which the liquefied gas sucked from the liquefied gas vessel and the gas having passed through the gas nozzle are introduced; and
a conveyance nozzle into which a mixture of the liquefied gas and the gas both having passed through the mixing nozzle is introduced.

17. The gas supply device according to claim 4, wherein
the injector includes a plurality of nozzles coaxially arranged, and
the plurality of nozzles include:
a gas nozzle into which the gas as the drive fluid is introduced;
a mixing nozzle into which the liquefied gas sucked from the liquefied gas vessel and the gas having passed through the gas nozzle are introduced; and
a conveyance nozzle into which a mixture of the liquefied gas and the gas both having passed through the mixing nozzle is introduced.

18. The gas supply device according to claim 5, wherein
the injector includes a plurality of nozzles coaxially arranged, and
the plurality of nozzles include:
a gas nozzle into which the gas as the drive fluid is introduced;
a mixing nozzle into which the liquefied gas sucked from the liquefied gas vessel and the gas having passed through the gas nozzle are introduced; and
a conveyance nozzle into which a mixture of the liquefied gas and the gas both having passed through the mixing nozzle is introduced.

19. The gas supply device according to claim 5, wherein the drive fluid supply path is led out from the gas vessel.
